(19) United States
(12) Patent Application Publication
(10) Pub. No.: US 2023/0134220 A1
(43) Pub. Date: May 4, 2023

(54) PACKING SYSTEM FOR STAGGERED PLACEMENT OF CYLINDRICAL CARGO WITH VARIABLE SPECIFICATIONS

(71) Applicants: Shandong University, Jinan (CN); Shandong University-Weihai Research Institute of Industrial Technology, Weihai (CN)

(72) Inventors: Xun CAI, Jinan (CN); Shuai XU, Jinan (CN); Xinyu LI, Jinan (CN); Yanbo GAO, Jinan (CN); Shuai LI, Jinan (CN); Bo ZHU, Jinan (CN); Jing WANG, Jinan (CN); Xiaohui SHI, Jinan (CN)

(21) Appl. No.: 17/973,027

(22) Filed: Oct. 25, 2022

(30) Foreign Application Priority Data
Oct. 29, 2021 (CN) 202111273106.5

(51) Int. Cl. B65G 65/00; B65G 65/02

(52) U.S. Cl. CPC B65G 65/005; B65G 65/02

(57) ABSTRACT

Disclosed is a packing system for staggered placement of cylindrical cargoes with variable specifications, which belongs to the field of logistics and transportation. The system comprises a role layer, a presentation layer, an application layer and a data layer; the presentation layer comprises a browser; the application layer is used to generate a container model and a cargo model, and the cargo models are grouped and put into a packing model; the application layer comprises cargo ordering, cargo grouping, container entry detection, cargo insertion, in-container coordinate calculation, out-of-container coordinate calculation, graphic display, information display, cancellation, local storage and database storage; and the data layer comprises container data and cargo data.

### CROSS-REFERENCE TO RELATED APPLICATIONS

This application claims priority to Chinese Patent Application No. 202111273106.5, filed on Oct. 29, 2021, the contents of which are hereby incorporated by reference.

### TECHNICAL FIELD

The application relates to the field of logistics and transportation, and in particular to a packing system for staggered placement of cylindrical cargo with variable specifications.

### BACKGROUND

With the vigorous development of logistics and transportation, the requirements for the utilization rate and efficiency of cargo packing are getting higher and higher.

For the object cylindrical cargo to be loaded, considering the actual packing situation of the cargo, these circles can only be tangent or separated, but cannot be intersected, and there will be gaps between these tangents or separated circles. According to the conventional cylindrical placement algorithm proposed by Dowsland et al., I layout (the number of circles in each row is equal) and Z layout (the number of circles in each row is equal, two adjacent rows are staggered left and right) and X layout (the difference of the number of circles between two adjacent rows is 1, and the shorter row is completely nested in the longer row) are possible. On the basis of the conventional column layout, in some factories' actual packing experience, there will be a case where a continuous number of cargoes are tangent and placed next to the container edge to achieve the maximum packing.

Because the layout directly affects the utilization rate of packing, it is impossible for people to choose the layout suitable for cylindrical cargo accurately, which leads to the waste of storage space. Therefore, aiming at the above problems, this paper puts forward a packing system for staggered placement of cylindrical cargo with variable specifications.

### SUMMARY

In order to make up for the shortcomings of the prior art and solve the problem that the layout directly affects the packing utilization rate, and the layout suitable for cylindrical cargo cannot be accurately selected manually, which easily leads to the waste of storage space, the application provides a packing system for staggered placement of cylindrical cargo with variable specifications.

The technical scheme adopted by the application to solve the technical problems is as follows: a packing system for staggered placement of cylindrical cargo with variable specifications includes a role layer, a presentation layer, an application layer and a data layer; the presentation layer includes a browser; the application layer is used to generate a container model and a cargo model, and the cargo models are grouped and put into a packing model; the application layer includes cargo ordering, cargo grouping, container entry detection, cargo insertion, in-container coordinate calculation, out-of-container coordinate calculation, graphic display, information display, cancellation, local storage and database storage; the data layer is used for finally obtaining the data of containers and the data of cargo ordering; the data layer includes container data and cargo data; open the browser of the presentation layer by the scheme makers of the role layer; after the browser is opened, the container is automatically generated, and then enter the application layer; then, the scheme makers can carry out cargo ordering, cargo grouping, container entry detection, cargo insertion, in-container coordinate calculation, out-of-container coordinate calculation, graphic display, information display, cancellation, local storage and database storage in the application layer, and then the container data and the cargo data may be generated by means of the data layer; after starting the system, containers with specified specifications (length, size and height) can be constructed; after the container is constructed, the cargo specification (roll diameter, number of trays, width) and error are input, and a batch of cylindrical cargo with this error range can be constructed; or the existing data files can be imported for packing cargo with specified specifications, the cargo to be packed are ordered in descending order of roll diameter, and the same roll diameters are ordered in descending order of package height, and then judge whether they can be packed into the container. For judging whether they can be packed into the container, the following conditions should be met:

1. The roll diameter of cylindrical cargo is less than or equal to the remaining container length and width of the current target position.

2. The package height (roll diameter*width) of cylindrical cargo is less than or equal to the remaining container height of the current target position.

If the cargo cannot be contained, an alarm message will be displayed, and the cargo that can be boxed will be grouped by a dynamic grouping algorithm. After that, cargo is inserted as much as possible to improve the packing rate; calculate the coordinates of cargo in the container: calculate the coordinates of plane circular parts by arc search algorithm, determine the height direction coordinates according to the height, customize the coordinates of cargo outside the container that cannot be entered, calculate the utilization rate of the container, and display the 3D images and related text information of cargo inside and outside the container. Users can choose to cancel and save data to local or database.

Variable Description:

cargo array G to be grouped

Array R after grouping

Number C of grouped cargo

Container height H

Current cargo height H

Current cargo group height NRH

Remaining height NRHR of current cargo group

Description of dynamic grouping algorithm: input G if C is equal to G length {grouping is completed} otherwise {if h>H {judge whether the cargo to be divided can be put into the container} otherwise {calculate NRH if NRH≤H {divide the cargo to be divided into the current group C by adding 1} otherwise divide the cargo to be divided into the next group}} add the current group to B} output B to count the number of cargo that have been grouped at present; if it is equal to the total number of cargoes to be grouped, then the grouping is completed; otherwise, the grouping operation is performed.

First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargo can be added to the current cargo group, and the number of cargo that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found.

Coordinate Calculation

1. Firstly, determine the coordinates of the first cargo in each group of cargo, and find the first cargo with a roll diameter not greater than the length and width of the container according to the arc search algorithm, and place it in the lower left corner of the container; if the current cargo is not the first one, then find the optimal placement position for the current cargo. The way to find the optimal placement position is to try every angle around the cylinder in front of the cargo, and find the right place and place the cargo; after that, the coordinates of the remaining cargo in each group are calculated. Since the coordinates of the first cargo in each group have been determined, and the plane direction coordinates of the remaining coordinates in each group are the same, it is enough to accumulate the heights to determine the height direction coordinates of each cargo.

2. Calculate the Container Utilization Rate

The container utilization rate is divided into a container bottom utilization rate and a container space utilization rate.

The container bottom utilization rate is the percentage of the total area of the lowest layer of loaded cargoes and the bottom area of the container; the container space utilization rate is the percentage of the total volume of loaded cargo and the volume of the container.

Optionally, the cargo ordering is to arrange the generated cargo model; the cargo grouping is to group the arranged models again; the container entry detection is to monitor whether the arranged and grouped cargo can enter the container model; the cargo insertion is to empty the container model to improve the packing rate.

Optionally, the graphic display displays a three-dimensional graphic of the cargo model placed in the container model; the information display displays the data of the last arrangement of the container model and the cargo model.

Optionally, the local storage is to save data files of the container model and the cargo model into a computer according to specified specifications; database storage is to upload the data files of container model and cargo model to the cloud.

Optionally, the operation processes of the role layer, the presentation layer, the application layer and the data layer are as follows: opening the browser to generate containers, and then inputting and submitting the cargo data; after that, ordering the cargo, then grouping the cargo, and then container entry detection is carried out; if the cargo cannot be put into the container, send out a warning message by means of information display; if the cargo is put into the container, continue to carry out the cargo grouping, the cargo insertion, the in-container coordinate calculation, and the out-of-container coordinate calculation; then display the graph and a utilization rate of the container, then choose whether to cancel the data, if not to cancel the data, save the data in the database and save text data. Data input includes container data and cargo data.

Converting the input data into coordinates; for the container, make a corner at the bottom of the container coincide with the origin of the three-dimensional coordinate system, and draw the container image; for cylindrical cargoes, order them first, and then use dynamic grouping algorithm to group the cylindrical cargoes; if the container entry condition is not met, it is impossible to participate in grouping; otherwise, continue; after that, the coordinates in the container are determined by combining the arc search algorithm and the height direction, and images and related information are displayed; for cargoes that cannot be put into the container, locate them directly away from the outside of the container, and display images and related information.

If the user chooses to cancel, the data will be restored to the initial state; if the user chooses to save the current packing scheme locally, the txt file of relevant data will be saved locally; if the user chooses to save the current scheme in the database, the relevant data will be saved in the designated database.

Optionally, the algorithm for calculating the coordinates inside and outside the container is to input the length, width and height of the container data, then construct a container model, and input the roll diameter, number of trays, amplitude and error of the cargo data; if the roll diameters are equal, the package heights are ordered in descending order, and if not, the roll diameters are ordered in descending order; if the number of grouped cargoes is equal to the total number of cargoes, grouping is completed; if the number of grouped cargoes is not equal to the total number of cargoes, grouping is continued; after grouping, calculate the coordinates of cargo, set the coordinates of cargo, display graphics, display the quantity of cargoes and display the container utilization rate. Firstly, a container model is constructed according to the container data (length, width and height) input by the user. Then, a specified number of cargoes with errors within the specified range are generated according to the cargo data (roll diameter, number of trays, width and error) input by the user. After that, these cargoes are ordered in descending order according to the package height (number of trays x width). If the roll diameters are the same, they are ordered in descending order according to the roll diameters. After ordering, perform dynamic grouping operation, that is, count the number of cargoes grouped at present; if it is equal to the total quantity of cargoes to be grouped, the grouping is completed, otherwise, the grouping operation is carried out. First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargo can be added to the current cargo group, and the number of cargoes that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found. After the dynamic grouping is finished, the insertion is carried out, that is, the cargo data is compared with the remaining space of each group from back to front. If it can be loaded, put the cargoes into the remaining space, and then calculate the coordinates of the cargoes. Firstly, the coordinates of the first cargo in each group of cargoes are determined, and according to the arc search algorithm, the first cargo with a roll diameter not larger than the length and width of the container are found and placed in the lower left corner of the container. If the current cargo is not the first one, then find the optimal placement position for the current cargo. The way to find the optimal placement position is to try every angle around the cylinder in front of the cargo, and find the right place to place the cargo; after that, the coordinates of the remaining cargoes in each group are calculated. Since the coordinates of the first cargo in each group have been determined, and the plane direction coordinates of the remaining coordinates in each group are the same, it is enough to accumulate the heights to determine the height direction coordinates of each cargoes, and transfer the calculated coordinates into the cargo object, and render the three-dimensional display effect on the page, and then display the quantity of cargoes and the container utilization rate.

The Application has the Advantages that:

The operation of the system is more concise, the effect and data display are more intuitive, and the use cost is lower, which means that it is easy to use, thus improving the efficiency of simulated packing. Aiming at the simulation placement of cylinder cargoes with variable specifications, the variable specifications include the roll diameter in the plane direction and the package height in the height direction, taking into account two dimensions at the same time, which makes the cylinder packing with variable specifications more targeted and the prediction of cylinder cargo packing more accurate.

### BRIEF DESCRIPTION OF THE DRAWINGS

In order to more clearly explain the embodiments of the present application or the technical solutions in the prior art, the following will briefly introduce the drawings to be used in the description of the embodiments or the prior art. Obviously, the drawings in the following description are only some embodiments of the present application. For those of ordinary skill in the art, other drawings mat be obtained according to these drawings without any creative labor.

FIG. 1 shows a packing system for staggered placement of cylindrical cargoes.

FIG. 2 shows the flow chart of software method.

FIG. 3 shows the sequence diagram of software algorithm.

FIG. 4 shows the Z layout diagram of the staggered placement of cylindrical cargoes.

FIG. 5 shows the X layout diagram of the staggered placement of cylindrical cargoes.

FIG. 6 shows the I layout diagram of the staggered placement of cylindrical cargoes.

FIG. 7 shows the conventional experience layout of the staggered placement of cylindrical cargoes.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. Based on the embodiment of the present application, all other embodiments obtained by ordinary technicians in the field without creative labor belong to the scope of protection of the present application.

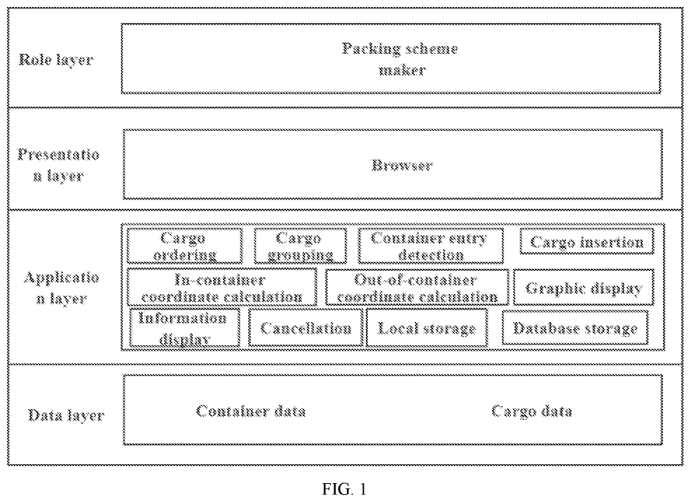

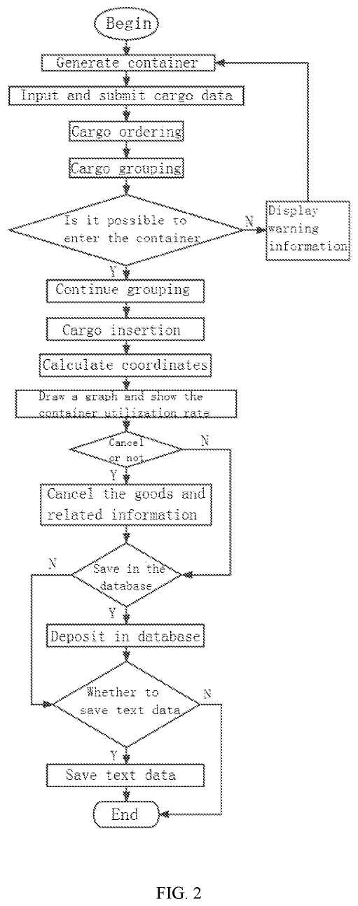

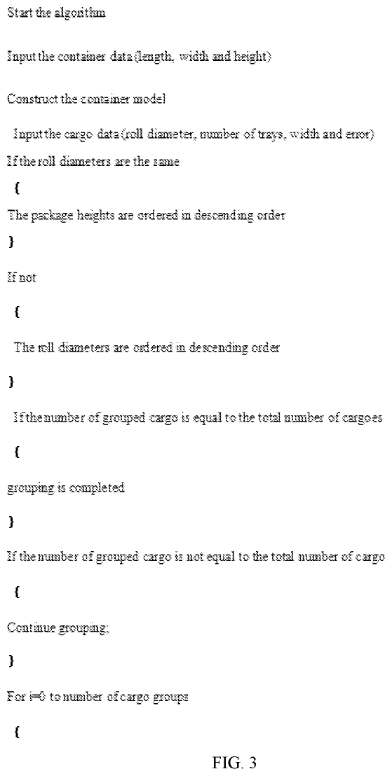

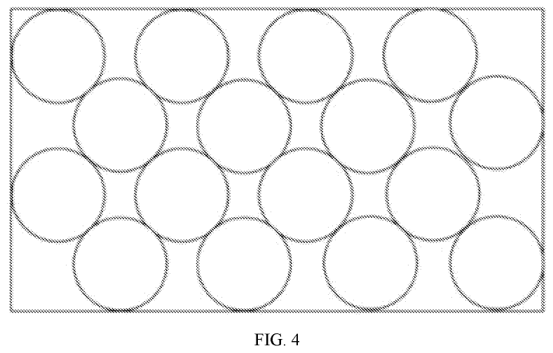

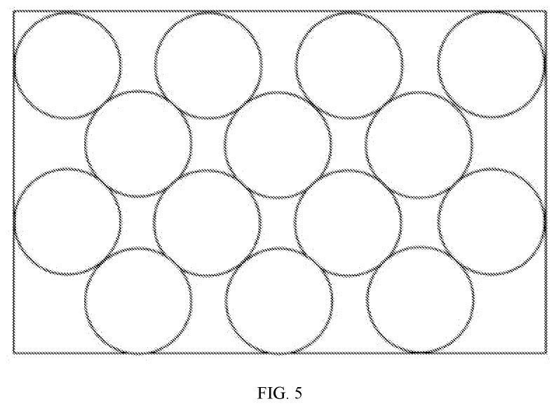

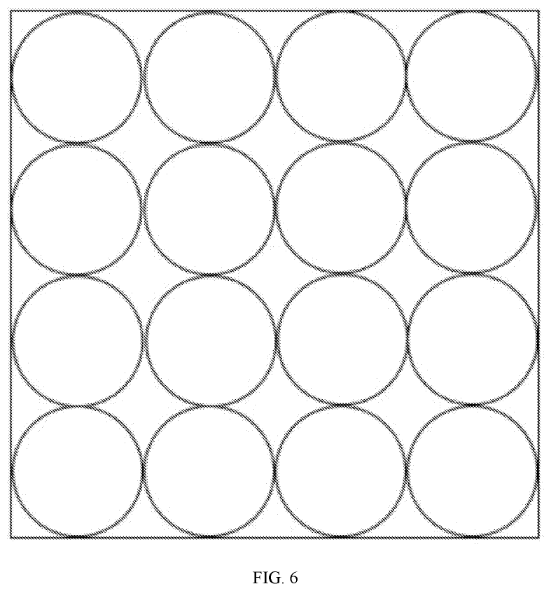

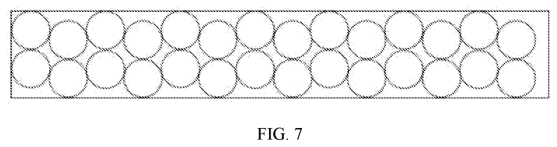

As shown in FIGS. 1-7, a packing system for staggered placement of cylindrical cargo with variable specifications includes a role layer, a presentation layer, an application layer and a data layer; the presentation layer includes a browser; the application layer is used to generate a container model and a cargo model, and the cargo models are grouped and put into a packing model; the application layer includes cargo ordering, cargo grouping, container entry detection, cargo insertion, in-container coordinate calculation, out-of-container coordinate calculation, graphic display, information display, cancellation, local storage and database storage; the data layer is used for finally obtaining the data of containers and the data of cargo ordering; the data layer includes container data and cargo data; open the browser of the presentation layer by the scheme makers of the role layer; after the browser is opened, the container is automatically generated, and then enter the application layer; then, the scheme makers can carry out cargo ordering, cargo grouping, container entry detection, cargo insertion, in-container coordinate calculation, out-of-container coordinate calculation, graphic display, information display, cancellation, local storage and database storage in the application layer, and then the container data and the cargo data may be generated by means of the data layer; after starting the system, containers with specified specifications (length, size and height) can be constructed; after the container is constructed, the cargo specification (roll diameter, number of trays, width) and error are input, and a batch of cylindrical cargo with this error range can be constructed; or the existing data files can be imported for packing cargo with specified specifications, the cargo to be packed are ordered in descending order of roll diameter, and the same roll diameters are ordered in descending order of package height, and then judge whether they can be packed into the container. For judging whether they can be packed into the container, the following conditions should be met:

1. The roll diameter of cylindrical cargo is less than or equal to the remaining container length and width of the current target position.

2. The package height (roll diameter*width) of cylindrical cargo is less than or equal to the remaining container height of the current target position.

If the cargo cannot be contained, an alarm message will be displayed, and the cargo that can be boxed will be grouped by dynamic grouping algorithm. After that, carry out cargo insertion for the cargo that can be inserted to improve the packing rate; calculate the coordinates of cargo in the container: calculate the coordinates of plane circular parts by arc search algorithm, determine the height direction coordinates according to the height, customize the coordinates of cargo outside the container that cannot be entered, calculate the utilization rate of the container, and display the 3D images and related text information of cargo inside and outside the container. Users can choose to cancel and save data to local or database.

Variable Description:

cargo array G to be grouped

Array R after grouping

Number C of grouped cargo

Container height H

Current cargo height H

Current cargo group height NRH

Remaining height NRHR of current cargo group

Description of dynamic grouping algorithm: input G if C is equal to G length {grouping is completed} otherwise {if h>H {judge whether the cargo to be divided can be put into the container} otherwise {calculate NRH if NRH≤H {divide the cargo to be divided into the current group C by adding 1} otherwise divide the cargo to be divided into the next group}} add the current group to B} output B to count the number of cargo that have been grouped at present; if it is equal to the total number of cargoes to be grouped, then the grouping is completed; otherwise, the grouping operation is performed.

First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargo can be added to the current cargo group, and the number of cargo that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found.

Coordinate Calculation

1. Firstly, determine the coordinates of the first cargo in each group of cargo, and find the first cargo with a roll diameter not greater than the length and width of the container according to the arc search algorithm, and place it in the lower left corner of the container; if the current cargo is not the first one, then find the optimal placement position for the current cargo. The way to find the optimal placement position is to try every angle around the cylinder in front of the cargo, and find the right place and place the cargo; after that, the coordinates of the remaining cargo in each group are calculated. Since the coordinates of the first cargo in each group have been determined, and the plane direction coordinates of the remaining coordinates in each group are the same, it is enough to accumulate the heights to determine the height direction coordinates of each cargo.

2. Calculate the Container Utilization Rate

The container utilization rate is divided into the container bottom utilization rate and the container space utilization rate.

The container bottom utilization rate is the percentage of the total area of the lowest layer of loaded cargoes and the bottom area of the container; the container space utilization rate is the percentage of the total volume of loaded cargo and the volume of the container.

The operation processes of the role layer, the presentation layer, the application layer and the data layer are as follows: opening the browser to generate containers, and then inputting and submitting the cargo data; after that, ordering the cargo, then grouping the cargo, and then container entry detection is carried out; if the cargo cannot be put into the container, send out a warning message by means of information display; if the cargo can be put into the container, continue to carry out the cargo grouping, the cargo insertion, the in-container coordinate calculation, and the out-of-container coordinate calculation; then display the graph and a utilization rate of the container, then choose whether to cancel the data, if not to cancel the data, save the data in the database and save text data. When working, converting the input data into coordinates; for the container, make a corner at the bottom of the container coincide with the origin of the three-dimensional coordinate system, and draw the container image; for cylindrical cargoes, order them first, and then use dynamic grouping algorithm to group the cylindrical cargoes; if the container entry condition is not met, it is impossible to participate in grouping; otherwise, continue; after that, the coordinates in the container are determined by combining the arc search algorithm and the height direction, and images and related information are displayed; for cargoes that cannot be put into the container, locate them directly away from the outside of the container, and display images and related information.

If the user chooses to cancel, the data will be restored to the initial state; if the user chooses to save the current packing scheme locally, the txt file of relevant data will be saved locally; if the user chooses to save the current scheme in the database, the relevant data will be saved in the designated database.

The cargo ordering is to arrange the generated cargo model; the cargo grouping is to group the arranged models again; the container entry detection is to monitor whether the arranged and grouped cargo can enter the container model; the cargo insertion is to empty the container model to improve the packing rate.

The graphic display displays a three-dimensional graphic of the cargo model placed in the container model; the information display displays the data of the last arrangement of the container model and the cargo model.

The local storage is to save data files of the container model and the cargo model into a computer according to specified specifications; database storage is to upload the data files of container model and cargo model to the cloud.

The algorithm for calculating the coordinates inside and outside the container is to input the length, width and height of the container data, then construct a container model, and input the roll diameter, number of trays, amplitude and error of the cargo data; if the roll diameters are equal, the package heights are ordered in descending order, and if not, the roll diameters are ordered in descending order; if the number of grouped cargoes is equal to the total number of cargoes, grouping is completed; if the number of grouped cargoes is not equal to the total number of cargoes, grouping is continued; after grouping, calculate the coordinates of cargo, set the coordinates of cargo, display graphics, display the quantity of cargoes and display the container utilization rate. Firstly, a container model is constructed according to the container data (length, width and height) input by the user. Then, a specified number of cargoes with errors within the specified range are generated according to the cargo data (roll diameter, number of trays, width and error) input by the user. After that, these cargoes are ordered in descending order according to the package height (number of trays x width). If the roll diameters are the same, they are ordered in descending order according to the roll diameters. After ordering, perform dynamic grouping operation, that is, count the number of cargoes that have been grouped at present; if it is equal to the total quantity of cargo to be grouped, the grouping is completed, otherwise, the grouping operation is carried out. First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargo can be added to the current cargo group, and the number of cargo that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found. After the dynamic grouping is finished, the insertion operation is carried out, that is, the cargo data is compared with the remaining space of each group from back to front. If it can be loaded, put the cargoes into the remaining space, and then calculate the coordinates of the cargoes. Firstly, the coordinates of the first cargo in each group of cargoes are determined, and according to the arc search algorithm, the first cargo with a roll diameter not larger than the length and width of the container are found and placed in the lower left corner of the container. If the current cargo is not the first one, then find the optimal placement position for the current cargo. The way to find the optimal placement position is to try every angle around the cylinder in front of the cargo, and find the right place and place the cargo; after that, the coordinates of the remaining cargo in each group are calculated. Since the coordinates of the first cargo in each group have been determined, and the plane direction coordinates of the remaining coordinates in each group are the same, it is enough to accumulate the heights to determine the height direction coordinates of each cargoes, and transfer the calculated coordinates into the cargo object, and render the three-dimensional display effect on the page, and then display the quantity of cargo and the container utilization rate.

Working principle: after starting the system, containers with specified specifications (length, size and height) can be constructed. After the container is constructed, the specifications (roll diameter, number of trays and width) and the error can be input to construct a batch of cylindrical cargoes with this error range, or import the existing data files for packing cargo with specified specifications, order the cargoes to be packed in descending order of roll diameter, and order the same roll diameters in descending order of package height, and then judge whether they can be packed into the container. For judging whether they can be packed into the container, the following conditions should be met:

1. The roll diameter of cylindrical cargo is less than or equal to the remaining container length and width of the current target position.

2. The package height (roll diameter*width) of cylindrical cargo is less than or equal to the remaining container height of the current target position.

If the cargo cannot be contained, an alarm message will be displayed, and the cargo that can be boxed will be grouped by dynamic grouping algorithm. After that, carry out cargo insertion for the cargo that can be inserted to improve the packing rate; calculate the coordinates of cargo in the container: calculate the coordinates of plane circular parts by arc search algorithm, determine the height direction coordinates according to the height, customize the coordinates of cargo outside the container that cannot be entered, calculate the utilization rate of the container, and display the 3D images and related text information of cargo inside and outside the container. Users can choose to cancel and save data to local or database.

Variable Description:

cargo array G to be grouped

Array R after grouping

Number C of grouped cargo

Container height H

Current cargo height H

Current cargo group height NRH

Remaining height NRHR of current cargo group

Description of dynamic grouping algorithm: input G if C is equal to G length {grouping is completed} otherwise {if h>H {judge whether the cargo to be divided can be put into the container} otherwise {calculate NRH if NRH≤H {divide the cargo to be divided into the current group C by adding 1} otherwise divide the cargo to be divided into the next group}} add the current group to B} output B to count the number of cargo that have been grouped at present; if it is equal to the total number of cargoes to be grouped, then the grouping is completed; otherwise, the grouping operation is performed.

First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargo can be added to the current cargo group, and the number of cargo that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found.

Coordinate Calculation

1. Firstly, determine the coordinates of the first cargo in each group of cargo, and find the first cargo with a roll diameter not greater than the length and width of the container according to the arc search algorithm, and place it in the lower left corner of the container; if the current cargo is not the first one, then find the optimal placement position for the current cargo. The way to find the optimal placement position is to try every angle around the cylinder in front of the cargo, and find the right place and place the cargo; after that, the coordinates of the remaining cargo in each group are calculated. Since the coordinates of the first cargo in each group have been determined, and the plane direction coordinates of the remaining coordinates in each group are the same, it is enough to accumulate the heights to determine the height direction coordinates of each cargo.

2. Calculate the Container Utilization Rate

The container utilization rate is divided into container bottom utilization rate and container space utilization rate.

The container bottom utilization rate is the percentage of the total area of the lowest layer of loaded cargoes and the bottom area of the container; the container space utilization rate is the percentage of the total volume of loaded cargo and the volume of the container. Converting the input data into coordinates; for the container, make a corner at the bottom of the container coincide with the origin of the three-dimensional coordinate system, and draw the container image; for cylindrical cargoes, order them first, and then use dynamic grouping algorithm to group the cylindrical cargoes; if the container entry condition is not met, it is impossible to participate in grouping; otherwise, continue; after that, the coordinates in the container are determined by combining the arc search algorithm and the height direction, and images and related information are displayed; for cargoes that cannot be put into the container, locate them directly away from the outside of the container, and display images and related information. Firstly, a container model is constructed according to the container data (length, width and height) input by the user. Then, a specified number of cargoes with errors within the specified range are generated according to the cargo data (roll diameter, number of trays, width and error) input by the user. After that, these cargoes are ordered in a descending order according to the package height (number of trays x width). If the roll diameters are the same, they are ordered in a descending order according to the roll diameters. After ordering, perform dynamic grouping operation, that is, count the number of cargoes that have been grouped at present; if it is equal to the total quantity of cargoes to be grouped, the grouping is completed, otherwise, the grouping operation is carried out. First, judge whether the height of the current cargo is greater than the container height, if so, the current cargo cannot be put into the container, and continue to judge the next cargo; when the cargo can be put into the container, add the height to the height of the current target cargo group to judge whether the cargo can join the group; if the height of the current group is not greater than the container height, it means that the current cargoes are added to the current cargo group, and the number of cargoes that have been grouped at present will increase, and the remaining height of the current group will be calculated; if the height of the current group is less than the height of the container, it means that the current cargoes are put into the container to exceed the specified height, and it is necessary to divide the current cargo into the next group until a suitable group is found. After the dynamic grouping is finished, the insertion operation is carried out, that is, the cargo data is compared with the remaining space of each group from back to front. If it can be loaded, put the cargoes into the remaining space, and then calculate the coordinates of the cargoes. Firstly, the coordinates of the first cargo in each group of cargoes are determined, and according to the arc search algorithm, the first cargo with a roll diameter not larger than the length and width of the container are found and placed in the lower left corner of the container. If the current cargo is not the first one, then find the optimal placement position for the current cargo. The way to find the optimal placement position is to try every angle around the cylinder in front of the cargo, and find the right place and place the cargo; after that, the coordinates of the remaining cargo in each group are calculated. Since the coordinates of the first cargo in each group have been determined, and the plane direction coordinates of the remaining coordinates in each group are the same, it is enough to accumulate the heights to determine the height direction coordinates of each cargoes, and transfer the calculated coordinates into the cargo object, and render the three-dimensional display effect on the page, and then display the quantity of cargo and the container utilization rate.

In the description of this specification, the description referring to the terms “one embodiment”, “example” and “specific example” means that the specific features, structures, materials or characteristics described in connection with this embodiment or example are included in at least one embodiment or example of the present application. In this specification, the schematic expressions of the above terms do not necessarily refer to the same embodiment or example. Furthermore, the specific features, structures, materials or characteristics described may be combined in any one or more embodiments or examples in a suitable manner.

The above shows and describes the basic principle, main features and advantages of the present application. It should be understood by those skilled in the art that the present application is not limited by the above-mentioned embodiments. The above-mentioned embodiments and descriptions only illustrate the principles of the present application. Without departing from the spirit and scope of the present application, there will be various changes and improvements of the present application, all of which fall within the scope of the claimed application.

What is claimed is:

1. A packing system for staggered placement of cylindrical cargoes with variable specifications, comprising a role layer, a presentation layer, an application layer and a data layer; wherein the presentation layer comprises a browser; the application layer is used to generate a container model and cargo models, and the cargo models are grouped and put into the container model; the application layer comprises cargo ordering, cargo grouping, container entry detection or not, cargo insertion, in-container coordinate calculation, out-of-container coordinate calculation, graphic display, information display, cancellation, local storage and database storage; the data layer is used for finally obtaining data of containers and data of cargo ordering; the data layer comprises the container data and the cargo data; after the browser of the presentation layer is opened by the scheme maker of the role layer, a container is automatically generated, and then enters the application layer; then the scheme maker carries out cargo ordering, cargo grouping, container entry or not detection, cargo insertion, in-container coordinate calculation, out-of-container coordinate calculation, graphic display, information display, cancellation, local storage and database storage in the application layer, and then the container data and the cargo data is generated by means of the data layer;
the cargo ordering is to arrange the generated cargo models; the cargo grouping is to group the arranged models again; the container entry detection is to monitor whether the arranged and grouped cargoes may enter the container model or not; and the cargo insertion is to empty the container model to improve the packing rate;
the algorithm for calculating the in-container coordinates and the out-container coordinates is to input a length, a width and a height of the container, then create the container model, and input the roll diameters, numbers of trays, widths and errors of the cargo data; if the roll diameters are equal, the package heights are ordered in a descending order; if not, the roll diameters are ordered in a descending order; if the number of the grouped cargoes is equal to the total number of the cargoes, grouping is completed; if the number of the grouped cargoes is not equal to the total number of the cargoes, grouping is continued; after grouping, cargo coordinates are calculated, and cargo coordinates, display graphics, display cargo quantity and display container utilization rates are set; and a package height is a number of trays multiplied by a width.

2. The packing system for staggered placement of cylindrical cargoes with variable specifications according to claim 1, wherein generated container coordinate data is obtained by calculating the in-container coordinates and the out-container coordinates.

3. The packing system for staggered placement of cylindrical cargoes with variable specifications according to claim 1, wherein the graphic display displays a three-dimensional graphic of the cargo models placed in the container model; the information display displays data of the last arrangement of the container model and the cargo models.

4. The packing system for staggered placement of cylindrical cargoes with variable specifications according to claim 1, wherein the local storage is to save data files of the container model and the cargo models into a computer according to specified specifications; the database storage is to upload the data files of container model and cargo models to a cloud.

5. The packing system for staggered placement of cylindrical cargoes with variable specifications according to claim 1, wherein operation processes of the role layer, the presentation layer, the application layer and the data layer are as follows: opening the browser to generate containers, and then inputting and submitting the cargo data; after that, ordering the cargoes, then grouping the cargoes, and then carrying out container entry or not detection; if the cargo may not be put into the container, sending out a warning message by means of the information display; if the cargoes may be put into the container, continuing to carry out the cargo grouping, the cargo insertion, the in-container coordinate calculation, and the out-of-container coordinate calculation; then displaying a graph and a utilization rate of the container, and then choosing whether to cancel the data; if the data is not cancelled, saving the data in the database and saving text data.
